(19) United States
(12) Patent Application Publication
(10) Pub. No.: US 2026/0257473 A1
(43) Pub. Date: Sep. 3, 2026

(54) LIQUID DISCHARGE APPARATUS AND METHOD FOR CONTROLLING LIQUID DISCHARGE APPARATUS

(71) Applicant: Katsuhiro ONO, Kanagawa (JP)

(72) Inventor: Katsuhiro ONO, Kanagawa (JP)

(73) Assignee: Ricoh Company, Ltd., Tokyo (JP)

(21) Appl. No.: 19/546,617

(22) Filed: Feb. 23, 2026

(30) Foreign Application Priority Data
Feb. 28, 2025 (JP) 2025-030956

(51) Int. Cl. B41J 2/045; B41J 2/165

(52) U.S. Cl. CPC B41J 2/0451; B41J 2/04581; B41J 2/04588; B41J 2/16579

(57) ABSTRACT

A liquid discharge apparatus includes: piezoelectric elements configured to apply pressure to dischargers each including a nozzle, voltage lines, each connected to a corresponding one of the piezoelectric elements, a driver configured to apply a drive voltage to the piezoelectric elements via the voltage lines, a selector configured to select the voltage lines after applying the drive voltage to the piezoelectric elements and to generate residual vibration data based on a sum of residual vibration voltages resulting from residual vibration on the selected voltage lines, an abnormality determiner configured to determine whether or not there is an abnormality in the residual vibration data by comparing the residual vibration data generated by the selector with a reference value, and a controller configured to detect a discharger having a discharge abnormality based on a determination result by the abnormality determiner, and the controller performs a first and second operation.

### CROSS-REFERENCE TO RELATED APPLICATIONS

The present application is based on and claims priority under 35 U.S.C. § 119 to Japanese Patent Application No. 2025-030956, filed on Feb. 28, 2025, the contents of which are incorporated herein by reference in their entirety.

### BACKGROUND OF THE INVENTION

### 1. Field of the Invention

The present disclosure relates to a liquid discharge apparatus and a method for controlling the liquid discharge apparatus.

### 2. Description of the Related Art

In a liquid discharge apparatus such as an inkjet printer, a drive signal is applied to a head on which a drive element such as a piezoelectric element is mounted, and ink droplets are discharged from nozzles provided in the inkjet recording head to print an image on a sheet or the like. Specifically, driving the drive element induces a pressure change in the ink within the pressure chamber of the inkjet recording head, thereby discharging ink droplets from the nozzles communicating with the pressure chamber.

In this type of liquid discharge apparatus, if ink in the nozzle increases in viscosity due to evaporation of an ink solvent from the nozzle or if air bubbles get mixed into the nozzle, an improper discharge of ink from the nozzle may occur. Therefore, a technique for inspecting a defective nozzle in which an improper discharge occurs, based on residual vibration occurring after inducing a pressure change in ink in a pressure chamber by a driving a drive element is known (For example, see Japanese Patent No. 4114638.).

In the case of detecting improper discharge of ink from a nozzle based on residual vibration, there is known a technique for shortening time taken for detecting residual vibration by overlapping some of the detection pulses used for detecting residual vibration of a plurality of nozzles within one period of a detection drive waveform (For example, see Japanese Unexamined Patent Application Publication No. 2017-039256.).

### SUMMARY OF THE INVENTION

A liquid discharge apparatus according to one embodiment of the present disclosure is provided with a plurality of piezoelectric elements configured to apply pressure to a plurality of dischargers each including a nozzle configured to discharge liquid; a plurality of voltage lines, each being connected to a corresponding one of the piezoelectric elements; a driver configured to apply a drive voltage to the plurality of piezoelectric elements via the plurality of voltage lines; a selector configured to select one or more of the voltage lines after applying the drive voltage to the plurality of piezoelectric elements and to generate residual vibration data based on a sum of residual vibration voltages resulting from residual vibration appearing on the selected voltage lines; an abnormality determiner configured to determine whether or not there is an abnormality in the residual vibration data by comparing the residual vibration data generated by the selector with a reference value for determining whether or not there is an abnormality in the residual vibration; and a controller configured to detect a discharger having a discharge abnormality based on a result of the determination performed by the abnormality determiner, wherein the controller performs: a first operation that: causes the driver to simultaneously apply a drive voltage to a target group that is one of a plurality of groups each including a predetermined number of the piezoelectric elements, causes the selector to simultaneously select a plurality of the voltage lines corresponding to the target group, and detects, when the abnormality determiner determines that there is an abnormality in the residual vibration data appearing on the selected plurality of voltage lines, that there is a discharge abnormality in at least one of the plurality of dischargers corresponding to the target group, and a second operation that, when the discharge abnormality is detected in the first operation, causes the driver to sequentially apply a drive voltage to the plurality of the piezoelectric elements in the target group, and causes the selector to sequentially select voltage lines to which the drive voltage was applied, and detects that there is a discharge abnormality in the discharger corresponding to the piezoelectric element in which an abnormality in the residual vibration data was determined by the abnormality determiner.

### BRIEF DESCRIPTION OF THE DRAWINGS

FIG. 1 is a block diagram illustrating a first embodiment of a liquid discharge apparatus according to the present disclosure;

FIG. 2 is a schematic side view illustrating an example of an inkjet recording head module mounted on the inkjet recording apparatus of FIG. 1;

FIG. 3 is a diagram illustrating an example of a nozzle plate provided on a bottom surface of an inkjet recording head of FIG. 2;

FIG. 4 is a block diagram illustrating an example of a circuit mounted on the inkjet recording head of FIG. 2;

FIG. 5 is a block diagram illustrating an overview of a circuit configuration of a driver and a selector of FIG. 4;

FIG. 6 is a timing diagram illustrating difference in waveforms of residual vibration voltages with and without switches illustrated in FIG. 5;

FIG. 7 is a block diagram illustrating an overview of the selector, a comparator, and a data storage of FIG. 4;

FIG. 8 is a timing diagram illustrating examples of residual vibration waveforms in accordance with the number of residual vibration voltages selected by the selector of FIG. 4;

FIG. 9 is a flow diagram illustrating an example of an initial operation performed before detection of a nozzle discharge abnormality caused by the inkjet recording head of FIG. 4;

FIG. 10 is a flow diagram illustrating an example of an operation for detecting a nozzle discharge abnormality caused by the inkjet recording head of FIG. 4;

FIG. 11 is a flow diagram illustrating an example of an operation for detecting a nozzle discharge abnormality caused by an inkjet recording head of a liquid discharge apparatus of a second embodiment according to the present disclosure; and

FIG. 12 is a block diagram illustrating an example of a hardware configuration of the inkjet recording head of FIG. 4.

### DESCRIPTION OF THE PREFERRED EMBODIMENTS

Embodiments will now be described with reference to the accompanying drawings. It should be noted that in each of the drawings, the same reference numerals are given to the same constituent parts, and redundant descriptions thereof may be omitted. A reference numeral indicating a signal may also be used as a reference numeral indicating a signal line, a signal terminal, or a signal node.

It is an objective of the present disclosure to shorten a determination time for determining a discharge abnormality of a plurality of dischargers including nozzles in a liquid discharge apparatus. In the liquid discharge apparatus, it is possible to shorten the time required for determining an abnormal discharge of a plurality of dischargers including nozzles.

Here, a liquid discharge apparatus that is an apparatus for discharging a liquid includes a liquid discharge head or a liquid discharge unit, and is configured to drive the liquid discharge head to discharge the liquid. The liquid discharge apparatus includes not only an apparatus capable of discharging a liquid onto an object to which the liquid can adhere, but also an apparatus for discharging the liquid into the air or into another liquid. For example, an apparatus on which the liquid discharge apparatus is mounted includes an image forming apparatus, a three-dimensional object fabrication apparatus, a treatment liquid applying apparatus, or a jet granulating apparatus. The treatment liquid applying apparatus may be mounted on an electrode manufacturing apparatus.

The liquid discharge apparatus may include means for feeding, conveying, or paper ejecting an object onto which the liquid can adhere, a pre-treatment apparatus, a post-treatment apparatus or the like.

For example, the apparatus on which the liquid discharge apparatus is mounted includes an image forming apparatus which forms an image on paper by discharging ink, and a three-dimensional object fabrication apparatus which discharges a fabrication liquid into a powder layer formed by layering powder in order to form a three-dimensional fabricated object.

Further, the liquid discharge apparatus is not limited to an apparatus that produces a meaningful image such as text or figures visualized by the discharged liquid. For example, the liquid discharge apparatus may be an apparatus for forming a meaningless pattern or the like or an apparatus for forming a three-dimensional image.

The expression “an object to which a liquid can adhere,” as used above, refers to an object to which a liquid can adhere at least temporarily, and includes objects to which the liquid adheres and solidifies, objects to which the liquid adheres and permeates, and the like. Specific examples include a recording medium such as paper, recording paper, recording paper, film, and cloth, an electronic circuit board, an electronic component such as a piezoelectric element, a powder layer (powder layer), an organ model, an inspection cell, and the like.

The above-described “object to which a liquid can adhere” may be made of a material such as paper, yarn, fiber, fabric, leather, metal, plastic, glass, wood, ceramics, or the like to which a liquid can adhere even temporarily.

The “liquid” may be any liquid that has a viscosity or surface tension capable of being discharged from the head. Although not particularly limited, it is preferable that the “liquid” has a viscosity of 30 mPa·s or less at room temperature and under normal pressure, or when heated or cooled. More specifically, the “liquid” is a solution, suspension, emulsion, or the like containing a solvent such as water or an organic solvent, a colorant such as a dye or a pigment, a polymerizable compound, a resin, a function-imparting material such as a surfactant, a biocompatible material such as DNA, an amino acid, a protein, and calcium, and an edible material such as a natural dye. These liquids can be used, for example, for inkjet inks, surface treatment liquids, liquids for forming components of electronic elements and light-emitting elements, resist patterns of electronic circuits, and liquid material for three-dimensional fabrication.

Also, although the ink droplet discharge apparatus is an apparatus in which the liquid discharge head and an object to which the liquid can adhere move relative to each other, the apparatus is not limited to this. Specific examples include a serial-type apparatus in which the liquid discharge head moves, a line type apparatus in which the liquid discharge head does not move, and the like.

In addition, other examples of the liquid discharge apparatus include a treatment liquid applying apparatus for discharging a treatment liquid onto a sheet in order to apply the treatment liquid to the surface of the sheet for the purpose of modifying the surface of the sheet, and an injection granulation apparatus for granulating fine particles of a raw material by jetting a composition liquid in which the raw material is dispersed in a solution through a nozzle.

Hereinafter, an embodiment will be described by taking as an example a case in which a liquid discharge apparatus is mounted on an image forming apparatus of a line-scanning type inkjet system in which “an object to which a liquid can adhere” is used as a sheet material.

### Liquid Discharge Apparatus in First Embodiment

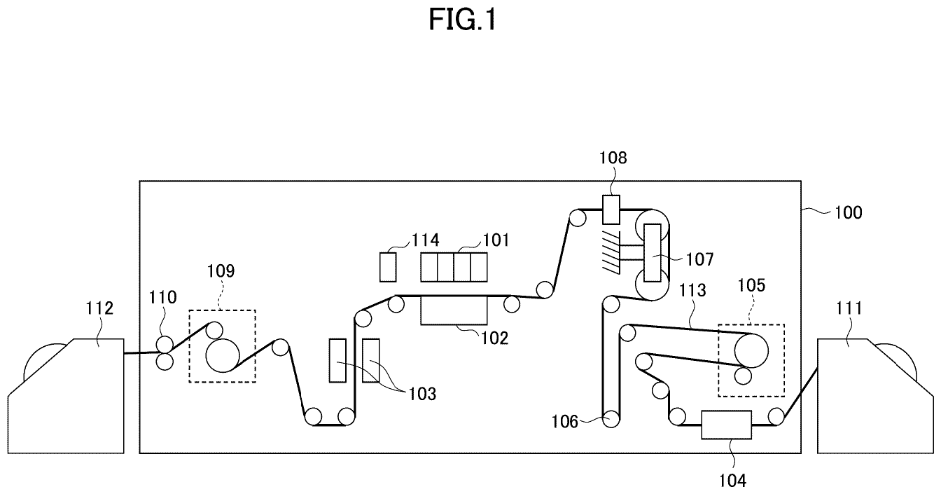

FIG. 1 is a block diagram illustrating a first embodiment of a liquid discharge apparatus according to the present disclosure. FIG. 1 is a schematic configuration diagram of a line-scanning type inkjet recording apparatus 100 according to the present embodiment as an example of a liquid discharge apparatus.

As illustrated in FIG. 1, the inkjet recording apparatus 100 is disposed between a recording medium supplier 111 and a recording medium recoverer 112, and includes recording means 101, a platen 102 provided opposite to the recording means 101, drying means 103, maintenance/recovery means 114, recording medium conveying device, and the like.

The recording medium conveying device includes a restriction guide 104, an in-feeder 105, a dancer roller 106, an EPC (edge position control) 107, a meandering amount detector 108, an out-feeder 109, a puller 110, and the like. A continuous recording medium (also referred to as roll paper, continuous paper, or the like.) 113 is fed at high speed from the recording medium supplier 111, and is wound and recovered by the recording medium recoverer 112.

### Inkjet Recording Head Module

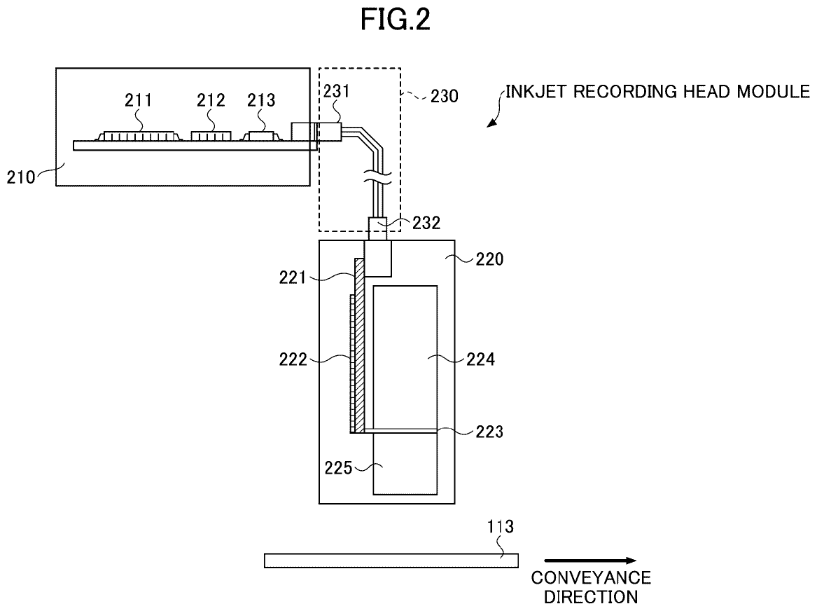

FIG. 2 is a schematic side view illustrating an example of an inkjet recording head module mounted on the inkjet recording apparatus 100 of FIG. 1. As illustrated in FIG. 2, the inkjet recording apparatus 100 includes a drive control board 210, an inkjet recording head 220, a cable 230, and the like.

A controller 211, a drive waveform generator 212, storage module 213, and the like are mounted on the drive control board 210. The inkjet recording head 220 includes a head board 221, a residual vibration detection board 222, a head drive IC board 223, an ink tank 224, a rigid plate 225, and the like. The cable 230 is connected to a drive control board-side connector 231 and the head-side connector 232, and transmits an analog signal or a digital signal between the drive control board 210 and the head board 221.

The line-scanning type inkjet recording apparatus 100 may have one or a plurality of the inkjet recording heads 220 arranged in a direction perpendicular to a conveyance direction of a recording medium 113 onto which droplets (ink) are deposited. The inkjet recording head 220 is provided with a plurality of nozzles arranged in rows corresponding to a width length of the recording medium 113 along a width direction of the recording medium 113. The inkjet recording head 220 discharges liquid droplets from the plurality of nozzles arranged in rows onto the recording medium 113, thereby enabling high-speed image formation.

Note that the ink droplet discharge apparatus according to this embodiment is also applicable to a serial scanning type inkjet recording apparatus or the like in which an image is formed by moving one or the plurality of inkjet recording heads in the direction perpendicular to the conveyance direction of the recording medium 113.

### Example of Nozzle Plate

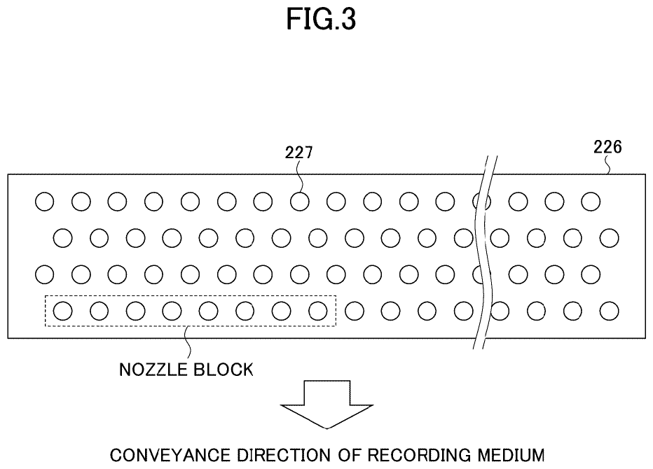

FIG. 3 is a diagram illustrating an example of a nozzle plate 226 provided on a bottom surface of the inkjet recording head 220 illustrated in FIG. 2. The nozzle plate 226 illustrated in FIG. 3 has a plurality of nozzles 227 (nozzle row) arranged in four rows in the direction perpendicular to the conveyance direction of the recording medium 113. For example, each nozzle row has the nozzles 227 in multiples of eight, and eight nozzles 227 are assigned to one nozzle block. A plurality of dischargers are formed, each discharger including a nozzle 227 and a pressure chamber (not illustrated) provided corresponding thereto. Hereinafter, the discharge abnormality of the discharger is also referred to as the discharge abnormality of the nozzle 227. Note that the number of rows provided on the nozzle plate 226 and the number of nozzles 227 included in each nozzle block are not limited to those described above. The nozzle blocks are provided corresponding to groups including a predetermined number of piezoelectric elements.

### Circuit Mounted on the Inkjet Recording Head

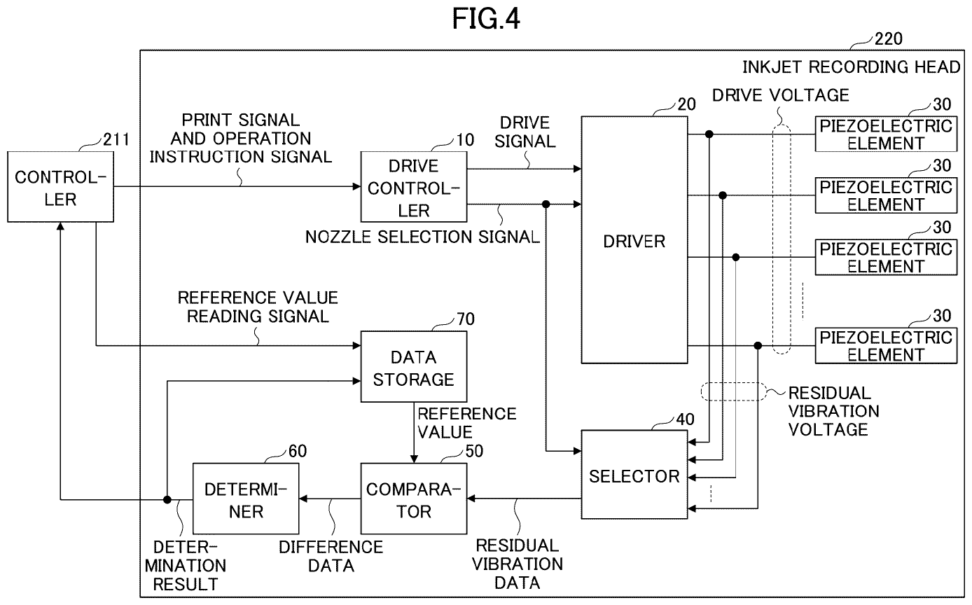

FIG. 4 is a block diagram illustrating an example of a circuit mounted on the inkjet recording head 220 illustrated in FIG. 2. The inkjet recording head 220 includes a drive controller 10, a driver 20, a plurality of piezoelectric elements 30, a selector 40, a comparator 50, a determiner 60, and a data storage 70. For example, the drive controller 10, the driver 20, a plurality of piezoelectric elements 30, the selector 40, the comparator 50, the determiner 60, and the data storage 70 are formed by a circuit.

Note that some functions of the drive controller 10 may be implemented by a processor such as a CPU. In this case, the comparator 50 and the determiner 60 may be implemented by a control program executed by the processor. The data storage 70 may be allocated to an internal memory mounted on the processor or to memory accessed by the processor.

The drive controller 10 receives a print signal, an operation instruction signal, or the like from the controller 211. For example, the controller 211 is a processor such as a CPU. The controller 211 controls the overall operation of the inkjet recording apparatus 100, but may control just the operation of the inkjet recording head 220. In such a case, the controller 211 may be provided in the inkjet recording head 220 or may be included in the drive controller 10. The drive controller 10 and the controller 211 are examples of the controller.

For example, the print signal includes information indicating the size of droplets discharged from the nozzles 227 for each nozzle 227 illustrated in FIG. 3. Thus, an image of gradation corresponding to the size of the droplet can be formed on the recording medium 113 illustrated in FIG. 2. For example, the operation instruction signal includes information indicating a nozzle row for discharging droplets, information indicating a piezoelectric element 30 (i.e., a drive voltage) to be selected by the selector 40, and information for instructing flushing of the nozzle 227 in which abnormality in residual vibration is detected. For example, abnormality in residual vibration occurs when ink in the nozzle 227 increases in viscosity due to evaporation of the ink solvent from the nozzle 227 or when air bubbles enter the nozzle.

Based on an instruction from the controller 211, the drive controller 10 outputs a drive signal to the driver 20 and outputs a nozzle selection signal to both the driver 20 and the selector 40. The drive signal includes information for driving each piezoelectric element 30. A nozzle selection signal is output corresponding to each of the nozzles 227, and is set to an active level (for example, high-level) when residual vibration of the piezoelectric element 30 corresponding to the nozzle 227 for discharging a liquid droplet is detected, and is set to an inactive level (for example, low level) when residual vibration of the piezoelectric element 30 is not detected.

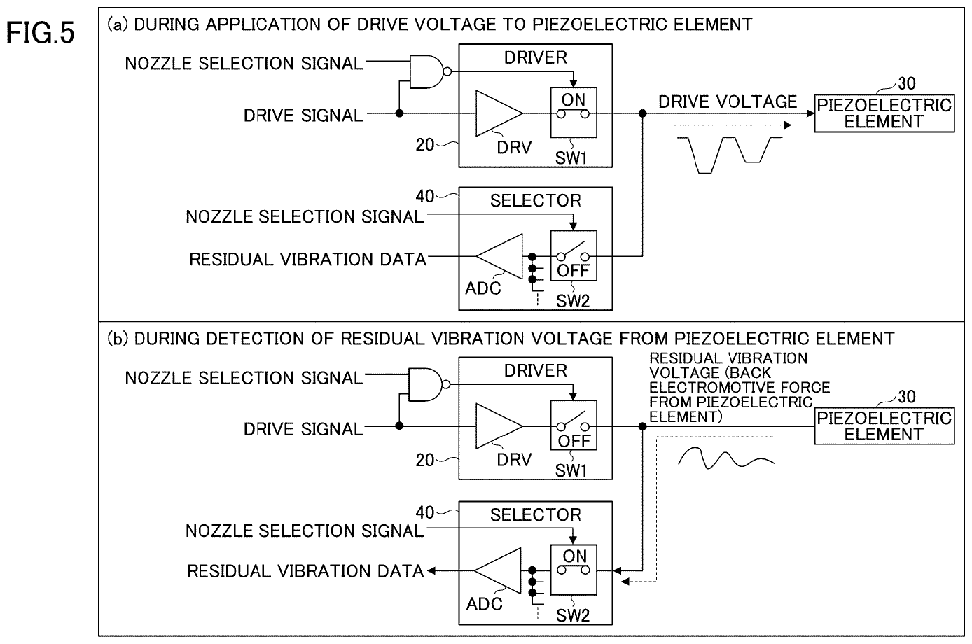

Based on the drive signal and the nozzle selection signal received from the drive controller 10, the driver 20 outputs a drive voltage to the piezoelectric element 30 corresponding to the nozzle 227 for discharging a liquid. The plurality of piezoelectric elements 30 are provided so as to correspond to each of the nozzles 227 provided on the nozzle plate 226 illustrated in FIG. 3. An example of the driver 20 is illustrated in FIG. 5. Each of the piezoelectric elements 30 operates in accordance with a corresponding drive voltage to cause the nozzle 227 to discharge liquid droplets.

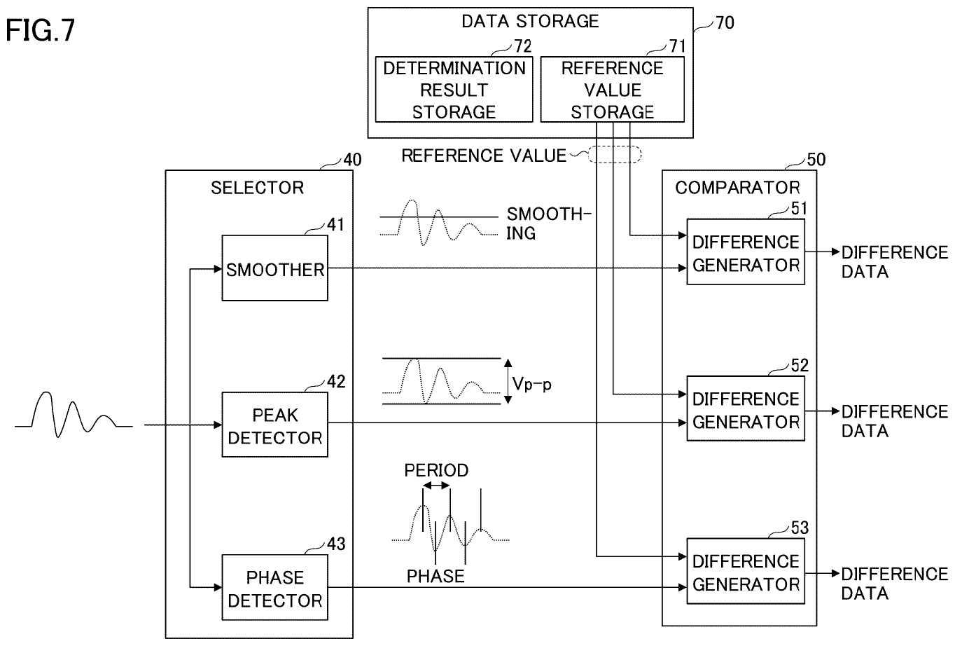

The selector 40 selects one or a plurality of drive voltage lines to be used for detecting residual vibration based on the nozzle selection signal received from the drive controller 10, converts the voltage values of the selected drive voltage lines into digital data comparable by the comparator 50, and outputs the converted data to the comparator 50 as residual vibration data. Note that the larger the number of drive voltage lines selected, the larger the sum of the voltage values input into the selector 40. Examples of the selector 40 are illustrated in FIGS. 5 and 7.

The comparator 50 compares the value of the residual vibration data with a reference value stored in the data storage 70, and outputs the difference data to the determiner 60. Examples of the comparator 50 are illustrated in FIG. 7.

The determiner 60 determines whether or not there is abnormality in the residual vibration data based on the difference data from the comparator 50. An abnormality in the residual vibration data indicates whether or not there is a possibility of a discharge abnormality in the nozzle 227 corresponding to the piezoelectric element 30 that has generated the residual vibration voltage selected by the selector 40. The determiner 60 outputs a result of the determination (i.e., a determination result) to the controller 211 and stores the determination result in the data storage 70. For example, the determination result includes information indicating a nozzle row or nozzle block determined as having a discharge abnormality and information indicating that abnormality in the residual vibration data has been determined. The comparator 50 and the determiner 60 are examples of abnormality determiners configured to determine whether or not there is an abnormality in the residual vibration data by comparing the residual vibration data with a reference value that is for determining whether or not there is an abnormality in the residual vibration.

The data storage 70 has a reference value storage configured to store a reference value used in the comparator 50 and a determination result storage configured to store the determination result obtained by the determiner 60. The data storage 70 reads out a reference value from the reference value storage based on a reference value reading signal received from the controller 211, and outputs the reference value to the comparator 50. An example of the data storage 70 is illustrated in FIG. 7.

### Overview of Circuit Configuration of Driver and Selector

FIG. 5 is a diagram illustrating an overview of a circuit configuration of the driver 20 and the selector 40 illustrated in FIG. 4. The driver 20 is provided corresponding to the piezoelectric element 30. The driver 20 has a driver DRV that generates a drive voltage in response to a drive signal from the drive controller 10, and a switch SW1 that is disposed between the driver DRV and the piezoelectric element 30, and operates in response to the drive signal and the nozzle selection signal. The switch SW1 is an example of the first switch.

The switch SW1 operates in response to the NAND logic of both the logic of the drive signal and the logic of the nozzle selection signal. For example, the switch SW1 turns on when both the drive signal is set to a low level and the drive voltage is applied to the piezoelectric element 30, and turns off when the nozzle selection signal is set to a high level in order to detect residual vibration. The low-level period of the drive signal and the high-level period of the nozzle selection signal are set to be mutually exclusive. The drive controller 10 illustrated in FIG. 4 generates a nozzle selection signal for each piezoelectric element 30.

The selector 40 includes an analog-to-digital converter (ADC) configured to convert an analog drive voltage into digital residual vibration data, and a switch SW2 that is disposed between the piezoelectric element 30 and the ADC and operates in response to a nozzle selection signal. For example, the switch SW2 is turned on when the nozzle selection signal is set to a high level for detecting residual vibration, and is turned off when the nozzle selection signal is set to a low level.

The selector 40 illustrated in FIG. 5 has only one switch SW2 connected to one piezoelectric element 30, but in actuality, the selector 40 has a plurality of switches SW2 connected to a plurality of piezoelectric elements 30 corresponding to a plurality of nozzles 227 included in the nozzle row. The ADC generates digital residual vibration data indicating changes in one or a plurality of residual vibration voltages supplied via the switch SW2 that is turned on in response to the nozzle selection signal among the plurality of switches SW2.

During a period when the piezoelectric element 30 is driven by the drive controller 10, the switch SW1 is on, and a drive voltage is applied to the piezoelectric element 30. During this time, since the switch SW2 is turned off, the ADC does not output residual vibration data. After the piezoelectric element 30 is driven, the switch SW2 is turned on in response to the nozzle selection signal being temporarily set to a high level. Thus, the ADC converts the voltage value of the residual vibration voltage due to the back electromotive force from the piezoelectric element 30 into digital data, and outputs the converted digital data as residual vibration data.

### Difference in Waveforms of Residual Vibration Voltages With and Without Switches

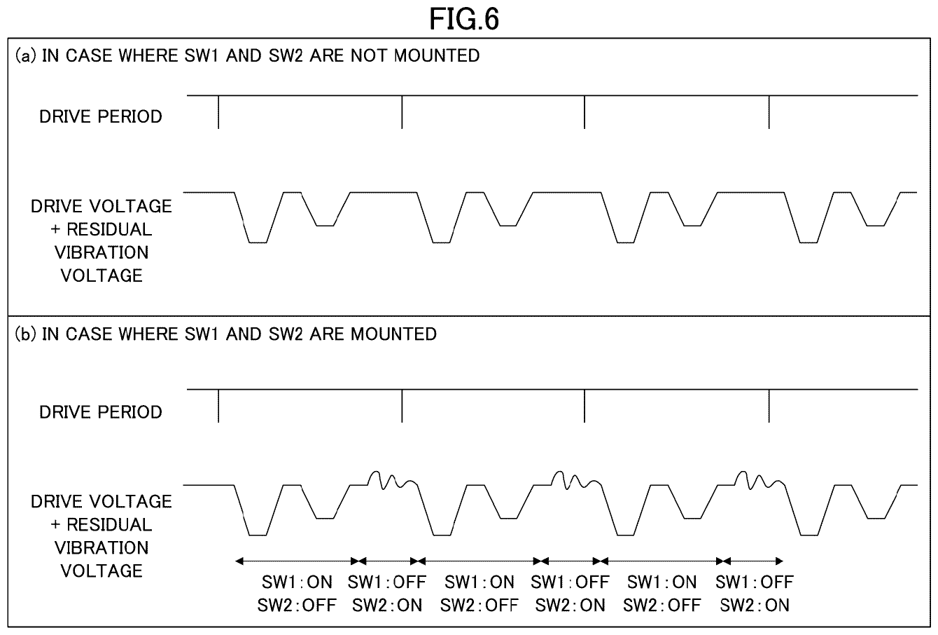

FIG. 6 is a timing diagram illustrating the difference in waveforms of the residual vibration voltages with and without the switches SW1 and SW2 illustrated in FIG. 5. In a case where the switches SW1 and SW2 are not mounted on the driver 20 and the selector 40, a load such as the output capacitance of the driver DRV of the driver 20 is connected to the drive voltage line.

Therefore, in the case where the switch SW1 is not mounted on the driver 20, a change in the residual vibration voltage due to residual vibration generated after the drive voltage is applied to the piezoelectric element 30 hardly appears on the drive voltage line, and consequently it becomes difficult to generate residual vibration data corresponding to the residual vibration voltage by the ADC. Furthermore, in the case where the switch SW2 is not mounted on the selector 40, residual vibration voltages from all the piezoelectric elements 30 are detrimentally input into the ADC. Moreover, when the drive voltage is applied to the piezoelectric element 30, part of the drive voltage is detrimentally input into the ADC of the selector 40, and consequently there is a possibility that a desired drive voltage may not be applied to the piezoelectric element 30.

In contrast to this, in a case where the switches SW1 and SW2 are respectively mounted on the driver 20 and the selector 40, after the drive voltage is applied to the piezoelectric element 30, a load such as the output capacitance of the driver DRV does not connect to the drive voltage line due to the switch SW1 being turned off. Therefore, the change in the residual vibration voltage due to the residual vibration can be increased. Further, the number of residual vibration voltages to be input into the ADC can be controlled in accordance with the nozzle selection signal. Further, by turning off the switch SW2, it is possible to prevent or substantially prevent the drive voltage from being input into the ADC when the drive voltage is applied to the piezoelectric element 30.

### Overview of Selector, Comparator, and Data Storage

FIG. 7 is a block diagram illustrating an overview of the selector 40, the comparator 50, and the data storage 70 illustrated in FIG. 4. The selector 40 further includes a smoother 41, a peak detector 42, and a phase detector 43 connected to the output of the ADC illustrated in FIG. 6. The comparator 50 includes difference generators 51, 52, and 53. The data storage 70 includes a reference value storage 71 and a determination result storage 72.

The selector 40 may include at least one of the smoother 41, the peak detector 42, or the phase detector 43. In this case, the comparator 50 has a difference generator corresponding to the smoother 41, the peak detector 42, or the phase detector 43 mounted on the selector 40. The smoother 41, the peak detector 42, and the phase detector 43 may be arranged between the selector 40 and the comparator 50, or may be arranged in the comparator 50.

The selector 40 operates one component among the smoother 41, the peak detector 42, and the phase detector 43 in response to a selection signal from the controller 211. The comparator 50 operates one difference generator (51, 52, or 53) corresponding to the smoother 41, the peak detector 42, or the phase detector 43 being operated, in response to a selection signal from the controller 211.

The smoother 41 smooths the voltage amplitude of the residual vibration data output from the ADC to obtain smoothed data, and outputs the smoothed data to the comparator 50. The peak detector 42 obtains peak values (maximum value and minimum value) of the amplitude of the voltage waveform from the residual vibration data output by the ADC, calculates the peak-to-peak voltage amplitude Vp-p, and outputs the peak value to the comparator 50. The phase detector 43 acquires the phase or period in which the peak values of the amplitude of the voltage waveform of the residual vibration data output by the ADC appear, and outputs it to the comparator 50.

The difference generator 51 compares the voltage value of the smoothed data acquired by the smoother 41 with the reference value of the smoothed data read out from the reference value storage 71, and outputs the difference between the voltage value of the smoothed data and the reference value as difference data. The difference generator 52 compares the value of the voltage amplitude Vp-p acquired by the peak detector 42 with the reference value of the voltage amplitude read from the reference value storage 71, and outputs the difference between the value of the voltage amplitude Vp-p and the reference value as difference data. The difference generator 53 compares the value indicating the phase or period acquired by the phase detector 43 with the reference value of the phase or period read out from the reference value storage 71, and outputs the difference between the value indicating the phase or period and the reference value as difference data.

The reference value storage 71 stores reference values corresponding to the number of nozzles in the nozzle row, the number of nozzles in the nozzle block, and the individual nozzles, respectively, corresponding to the voltage value output from the smoother 41, the value of the voltage amplitude Vp-p output from the peak detector 42, and the value indicating the phase or period output from the phase detector 43. For example, the reference value is determined by evaluation performed when the inkjet recording apparatus 100 is under development.

The determination result storage 72 stores the determination result obtained by the determiner 60. For example, the determination result storage 72 stores, as a determination result, frequency information indicating the occurrence of abnormalities in the residual vibration data, such as the number of nozzle blocks and the count of nozzles where such abnormalities were detected. Further, the determination result storage 72 stores a reference frequency (the number of nozzle blocks and the number of nozzles) for determining whether the occurrence frequency of the abnormality is high or low.

### Example of Residual Vibration Data Corresponding to Number of Residual Vibration Voltages

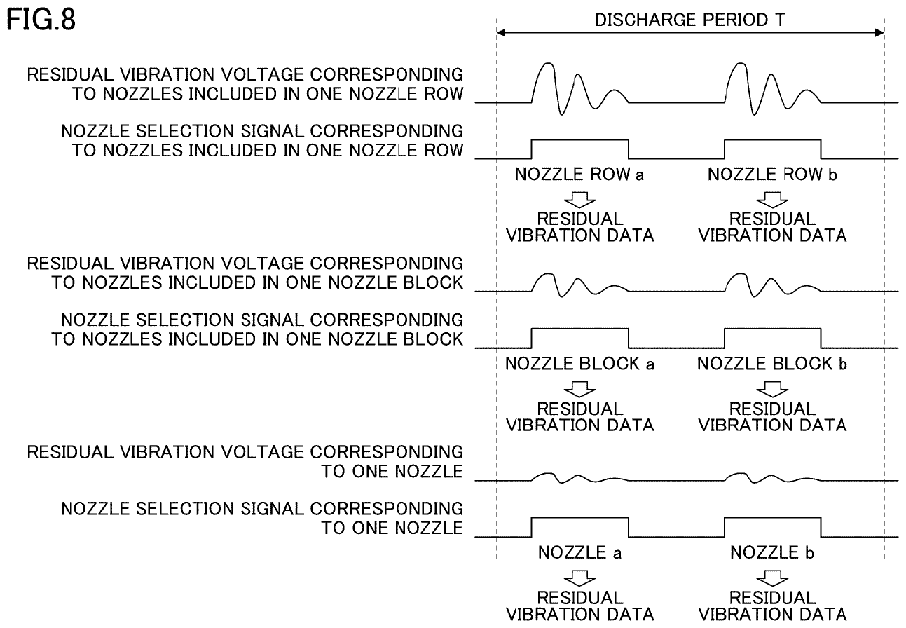

FIG. 8 is a timing diagram illustrating an example of residual vibration data corresponding to the number of residual vibration voltages selected by the selector 40 of FIG. 4. For example, the selector 40 generates residual vibration data by converting the voltage value of the residual vibration data corresponding to the nozzles 227 included in one nozzle row, the residual vibration data corresponding to the nozzles 227 included in one nozzle block, or the residual vibration voltage corresponding to one nozzle 227, into digital values.

As the number of residual vibration voltages generated by the residual vibration data increases, the signal amount of the residual vibration voltage input into the ADC increases, and the amplitude of the waveform of the residual vibration data increases. Then, the comparator 50 compares the residual vibration data generated in accordance with the number of residual vibration voltages with a reference value corresponding to the number of residual vibration voltages in order to output difference data. The comparator 50 compares the residual vibration data having different amplitudes according to the number of residual vibration voltages with a reference value having different amplitudes according to the number of residual vibration voltages so as to correctly determine whether or not there is a discharge abnormality. Although FIG. 8 illustrates an example in which the nozzle selection signal is generated twice in one discharge period T to generate two pieces of residual vibration data, three or more pieces of residual vibration data may be generated if one discharge period T is further increased.

### Initial Operation of the Inkjet Recording Head

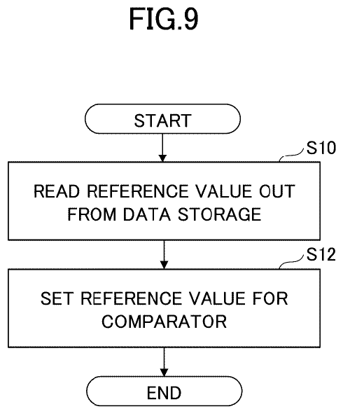

FIG. 9 is a flow diagram illustrating an example of an initial operation performed before the discharge abnormality of the nozzle 227 is detected by the inkjet recording head 220 of FIG. 4. For example, the operation illustrated in FIG. 9 is performed by the controller 211 when the inkjet recording apparatus 100 is started.

First, in step S10, the controller 211 reads out a reference value from the data storage 70. Next, in step S12, the controller 211 sets the reference value read out from the data storage 70 in a buffer, a register, or the like of the comparator 50, and ends the operation illustrated in FIG. 9.

### Operation Flow for Detecting Abnormal Discharge of Nozzle

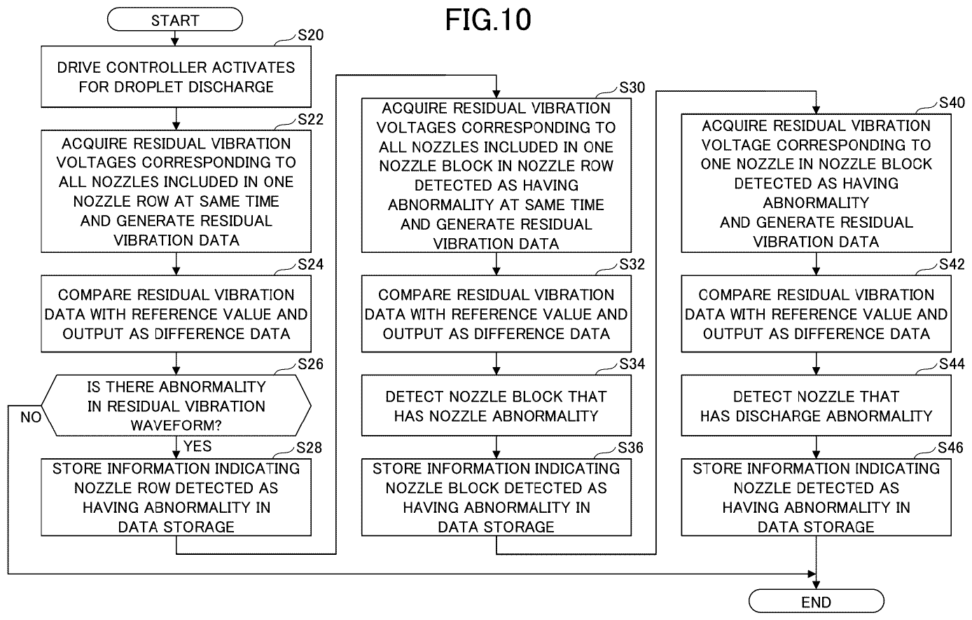

FIG. 10 is a flow diagram illustrating an example of an operation for detecting a discharge abnormality of a nozzle 227 by the inkjet recording head 220 of FIG. 4. For example, the flow illustrated in FIG. 10 is performed when the inkjet recording apparatus 100 is started, either before or after the inkjet recording head 220 discharges liquid droplets onto the recording medium 113. The flow illustrated in FIG. 10 may be performed after temporarily interrupting the discharge of the liquid droplets onto the recording medium 113 by the inkjet recording head 220 while the discharge is underway.

First, in step S20, the drive controller 10 is activated in order to discharge the liquid droplets in response to an instruction from the controller 211. In steps S22 to S28, it is detected whether or not there is an discharge abnormality in at least one of the nozzles 227 included in one nozzle row. When the nozzle plate 226 has a plurality of nozzle rows, the operations in steps S22 to S28 may be repeated for the number of nozzle rows. The operation in step S22 to step S28 are an example of the third operation.

After step S20, in step S22, the drive controller 10 simultaneously applies a drive voltage to the piezoelectric elements 30 corresponding to all the nozzles 227 included in one nozzle row. The selector 40 simultaneously acquires a plurality of residual vibration voltages generated in accordance with a drive voltage applied to the piezoelectric elements 30 corresponding to all the nozzles 227 included in one nozzle row, and generates residual vibration data corresponding to the sum of the residual vibration voltages.

Next, in step S24, the comparator 50 compares the residual vibration data generated by the selector 40 with a reference value for detecting a discharge abnormality of the nozzle row, and outputs the comparison result as difference data to the determiner 60. Next, in step S26, the determiner 60 determines whether or not there is an abnormality in the residual vibration data (that is, the residual vibration waveform and the residual vibration voltage) based on the difference data.

If there is an abnormality in the residual vibration data, the operation proceeds to step S28. Conversely, if there is no abnormality in the residual vibration data, the operation for detecting a discharge abnormality of the nozzles 227 is terminated, on the basis that no discharge abnormality exist in any of the nozzles 227 in the nozzle row that is subject to abnormality detection. That is, if there is no abnormality in the residual vibration data in step S26, the process of determining discharge abnormalities on a per-nozzle 227 basis can be skipped, and the operation for detecting a discharge abnormalities can be terminated.

In step S28, the determiner 60 stores, in the determination result storage 72 of the data storage 70, both information indicating the nozzle row detecting as having a discharge abnormality and information indicating that the abnormality in the residual vibration data has been determined, as the determination result. That is, the occurrence history of the abnormality in the residual vibration data of the nozzle row that is subject to abnormality detection is stored in the determination result storage 72.

After step S28, steps S30 to S36 are performed. In steps S30 to S36, it is detected whether or not at least one of the nozzles 227 included in each of the plurality of nozzle blocks included in the nozzle row in which an abnormality in the residual vibration waveform was detected has a discharge abnormality. The operation from step S30 to step S36 is repeated as many times as the number of nozzle blocks included in the nozzle row in which the abnormality in the residual vibration data was detected. The operation from step S30 to step S36 is an example of a first operation.

First, in step S30, the drive controller 10 simultaneously applies a drive voltage to the piezoelectric elements 30 corresponding to all the nozzles 227 included in one of the plurality of nozzle blocks included in the nozzle row in which the abnormality in the residual vibration data is detected. The selector 40 simultaneously acquires a plurality of residual vibration voltages generated in accordance with the drive voltage applied to the piezoelectric elements 30 corresponding to all the nozzles 227 included in one nozzle block in the nozzle row in which the abnormality in the residual vibration data was detected, and generates residual vibration data.

Next, in step S32, the comparator 50 compares the residual vibration data generated by the selector 40 with a reference value for detecting the discharge abnormality of the nozzle block, and outputs the comparison result as difference data to the determiner 60. Next, in step S34, the determiner 60 detects the nozzle block having abnormality in the residual vibration data (that is, the residual vibration waveform and the residual vibration voltage) as the nozzle block having discharge abnormality based on the difference data. Next, in step S36, the determiner 60 stores information indicating the nozzle block in which an abnormality was detected, as a determination result, in the determination result storage 72 of the data storage 70. That is, the occurrence history of abnormality in the residual vibration data of the nozzle block including the nozzle 227 having discharge abnormality is stored in the determination result storage 72.

After step S36, steps S40 to S46 are performed. In steps S40 to S46, among the plurality of nozzles 227 included in the nozzle block having a detected abnormality in the residual vibration data, the nozzle 227 having a discharge abnormality is detected. The operation from step S30 to step S36 is repeated as many times as the number of nozzles 227 included in the nozzle block in which a discharge abnormality was detected. The operation from step S40 to step S46 is an example of a second operation.

First, in step S40, the drive controller 10 applies a drive voltage to the piezoelectric element 30 corresponding to one of the plurality of nozzles 227 included in the nozzle block in which the abnormality in the residual vibration data was detected. The selector 40 acquires a residual vibration voltage generated in accordance with a drive voltage applied to the piezoelectric element 30 corresponding to one nozzle 227 within the nozzle block in which the abnormality in the residual vibration data was detected, and generates residual vibration data.

Next, in step S42, the comparator 50 compares the residual vibration data generated by the selector 40 with a reference value for detecting the discharge abnormality of the nozzle 227, and outputs the comparison result as difference data to the determiner 60. Next, in step S44, the determiner 60 detects the nozzle 227 having the abnormality in the residual vibration data (that is, the residual vibration waveform and the residual vibration voltage) as the nozzle 227 having the discharge abnormality, based on the difference data. Next, in step S46, the determiner 60 stores, in the determination result storage 72 of the data storage 70, information indicating the nozzle 227 having the discharge abnormality, as the determination result. That is, the occurrence history of the nozzle 227 in which the discharge abnormality has occurred is stored in the determination result storage 72. Since the nozzle 227 having the discharge abnormality was detected, the operation illustrated in FIG. 10 is terminated.

As described above, in the first embodiment, the controller 211 detects whether or not the discharge abnormality is present in at least one of the nozzles 227 included in each of the plurality of nozzle blocks included in one nozzle row, and detects the nozzle 227 having the discharge abnormality from among the plurality of nozzles 227 included in the nozzle block in which the discharge abnormality was detected. Thus, it is not necessary to detect whether or not the discharge abnormality is present in each of the nozzles 227 included in the nozzle row, thereby shortening the determination time required for determining whether or not the discharge abnormality is present in the nozzle 227.

Varying the reference values in accordance with whether the residual vibration data is analyzed on a nozzle-row, nozzle-block, or individual nozzle basis ensures that discharge abnormalities are detected accurately. The determination time required for determining whether a discharge abnormality is present in the nozzle 227 can be further shortened by detecting whether the abnormality in the residual vibration data is present in the nozzle row including a plurality of nozzle blocks, before detecting whether an abnormality in the residual vibration data is present on a nozzle-block basis.

After the application of the drive voltage to the piezoelectric element 30, a load such as the output capacitance of the driver DRV is prevented or substantially prevented from being connected to the drive voltage line due to the switch SW1 being turned off, thereby increasing the change of the residual vibration voltage due to the residual vibration. Furthermore, when the drive voltage is applied to the piezoelectric element 30, the input of the drive voltage into the ADC can be prevented or substantially prevented by turning the switch SW2 off.

The comparator 50 smooths the voltage amplitude of the residual vibration data and generates difference data by comparing the smoothed data, the peak value of the amplitude of the voltage waveform of the residual vibration data, or either the phase or period of the peak value of the voltage waveform of the residual vibration data with the corresponding reference value. Thus, it is possible to detect whether or not there is a discharge abnormality by selectively using various feature values obtained from the residual vibration data.

### Liquid Discharge Apparatus of Second Embodiment

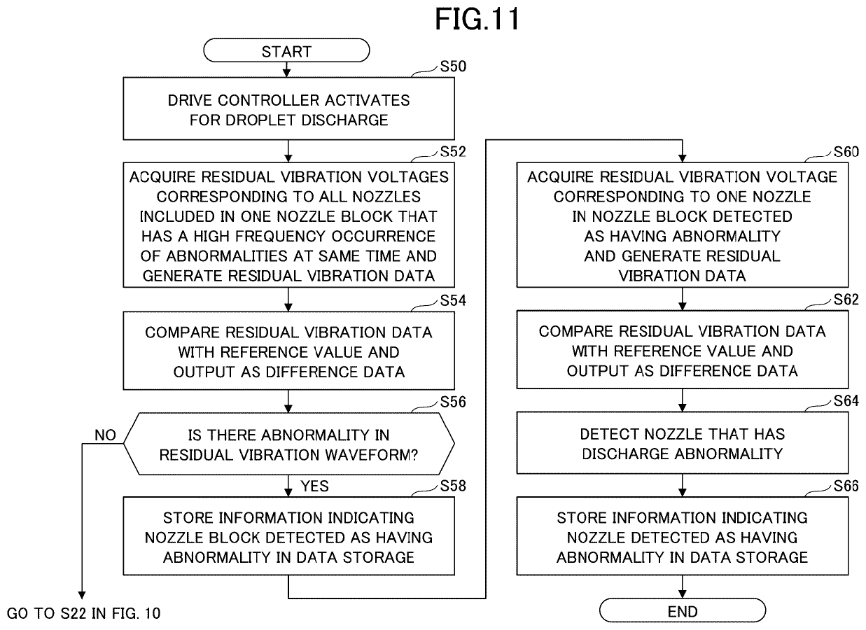

FIG. 11 is a flow diagram illustrating an example of an operation for detecting a discharge abnormality of a nozzle 227 by the inkjet recording head 220 of a liquid discharge apparatus of the second embodiment according to the present disclosure. For example, the flow illustrated in FIG. 11 is performed when the inkjet recording apparatus 100 is started, either before or after the inkjet recording head 220 discharges a liquid droplet onto the recording medium 113. The flow illustrated in FIG. 11 may be performed after temporarily interrupting the discharge of the liquid droplets onto the recording medium 113 by the inkjet recording head 220 while the discharge is underway.

The configuration of the liquid discharge apparatus of the second embodiment is substantially the same as that of FIGS. 1 to 5 and 7, and the basic operation of the liquid discharge apparatus according to the second embodiment is substantially the same as that of FIGS. 6, 8 and 9. The operation illustrated in FIG. 11 is performed before the operation illustrated in FIG. 10 according to the frequency of occurrence of abnormalities. When there is a plurality of nozzle blocks in which the frequency of abnormality of residual vibration is high, the operations of steps S52 to S66 are performed for each nozzle block.

First, in step S50, the drive controller 10 is activated in order to discharge liquid droplets in response to an instruction from the controller 211. After step S50, steps S52 to S58 are performed. In steps S52 to S58, it is detected whether or not at least one of the nozzles 227 of the nozzle block with a high frequency of residual vibration abnormalities has a discharge abnormality. The operation from step S52 to step S58 is an example of a fourth operation.

In step S52, based on the occurrence history of abnormalities in the residual vibration data of the nozzle block stored in the determination result storage 72, the drive controller 10 simultaneously applies a drive voltage to the piezoelectric elements 30 corresponding to all the nozzles 227 included in one of the nozzle blocks detected as having a high frequency of abnormalities in the residual vibration data. The selector 40 simultaneously acquires a plurality of residual vibration voltages generated in accordance with the drive voltage applied to the piezoelectric elements 30 corresponding to all the nozzles 227 included in one of the nozzle blocks detected as having a high frequency of abnormalities in the residual vibration data, and generates residual vibration data.

Next, in step S54, the comparator 50 compares the residual vibration data generated by the selector 40 with a reference value for detecting discharge abnormality of the nozzle block, and outputs the comparison result as difference data to the determiner 60. Next, in step S56, the determiner 60 determines whether or not there is abnormality in the residual vibration data (that is, the residual vibration waveform and the residual vibration voltage) based on the difference data. If there is abnormality in the residual vibration data, the operation proceeds to step S58.

If there is no abnormality in the residual vibration data, all the nozzles 227 of the nozzle block in which the abnormality was detected are free from discharge abnormalities. However, since a discharge abnormality may still exist in one of the nozzles 227 of another nozzle block that was not the subject of abnormality detection, the process proceeds to step S22 of FIG. 10 of the first embodiment. It is to be noted that there is a high possibility that the other nozzle block that was not the subject of abnormality detection will be determined as being free from abnormalities at step S26 of FIG. 10 because the occurrence frequency of the residual vibration abnormalities is low.

In step S58, the determiner 60 stores information indicating the nozzle block in which the abnormality was detected, as a determination result, in the determination result storage 72 of the data storage 70. That is, the occurrence history of the abnormality in the residual vibration data of the nozzle block including the nozzle 227 with the discharge abnormality is stored in the determination result storage 72.

After step S58, steps S60 to S66 are performed. In steps S60 to S66, similarly to steps S40 to S46 in FIG. 10, the nozzle 227 with the discharge abnormality is detected from among the plurality of nozzles 227 included in the nozzle block in which the abnormality in the residual vibration data was detected. The operation from step S60 to step S66 is repeated as many times as the number of nozzles 227 included in the nozzle block in which the abnormality in the residual vibration data was detected. The operation from step S60 to step S66 is an example of the second operation.

First, in step S60, the drive controller 10 applies a drive voltage to the piezoelectric element 30 corresponding to one of the plurality of nozzles 227 included in the nozzle block in which the abnormality in the residual vibration data was detected. The selector 40 acquires the residual vibration voltage generated in accordance with the drive voltage applied to the piezoelectric element 30 corresponding to one nozzle 227 within the nozzle block in which the abnormality in the residual vibration data was detected, and generates residual vibration data.

Next, in step S62, the comparator 50 compares the residual vibration data generated by the selector 40 with a reference value for detecting the discharge abnormality of the nozzle 227, and outputs the comparison result as difference data to the determiner 60. Next, in step S64, the determiner 60 detects the nozzle 227 having an abnormality in the residual vibration data (that is, the residual vibration waveform and the residual vibration voltage) as the nozzle 227 having the discharge abnormality, based on the difference data. Next, in step S66, the determiner 60 stores, in the determination result storage 72 of the data storage 70, information indicating the nozzle 227 having the discharge abnormality, as a determination result. That is, the occurrence history of the nozzle 227 in which the discharge abnormality has occurred is stored in the determination result storage 72. Since the nozzle 227 having the discharge abnormality was detected, the operation illustrated in FIG. 11 is terminated.

As described above, in the second embodiment, similarly to the first embodiment, when it is detected that any of the plurality of nozzle blocks included in one nozzle row has a discharge abnormality, the nozzle 227 having the discharge abnormality is detected from among the plurality of nozzles 227 included in the nozzle block in which the discharge abnormality is detected, thereby shortening the determination time for determining whether or not the nozzle 227 has a discharge abnormality.

Furthermore, in the second embodiment, information indicating the nozzle block in which the abnormality in the residual vibration data is detected is stored in the determination result storage 72, and when there is an abnormality in the residual vibration data of the nozzle block in which the abnormality in the residual vibration data occurs with a high frequency, the nozzle 227 having the discharge abnormality is detected from the nozzle block in which the abnormality occurs. The nozzle 227 in which the discharge abnormality was detected in the past may be more likely to cause the discharge abnormality again than other nozzles 227. By determining the nozzle block in which the abnormality in the residual vibration data was detected according to the occurrence frequency of the abnormality, the nozzle 227 having the discharge abnormality can be efficiently detected, and the determination time for determining whether or not the nozzle 227 has a discharge abnormality can be further shortened.

Furthermore, in the second embodiment, when there is no abnormality in the nozzle block in which the abnormality in the residual vibration data occurs with a high frequency, the detection operation of the abnormality in the residual vibration data of the nozzle row including the nozzle block in which the abnormality occurs with a low frequency (FIG. 10) is performed. By detecting the abnormality in the residual vibration data from the nozzle block in which the abnormality occurs with a high frequency, the probability of detecting the abnormality in the residual vibration data in step S26 of FIG. 10 can be reduced as compared to the case where the detection operation of the abnormality of the nozzle block in which the abnormality occurs with a high frequency is not performed. Therefore, the probability of performing the operation after step S28 of FIG. 10 can be reduced, and the determination time for determining whether or not the nozzle 227 has a discharge abnormality can be shortened.

### Hardware Configuration of Inkjet Recording Head

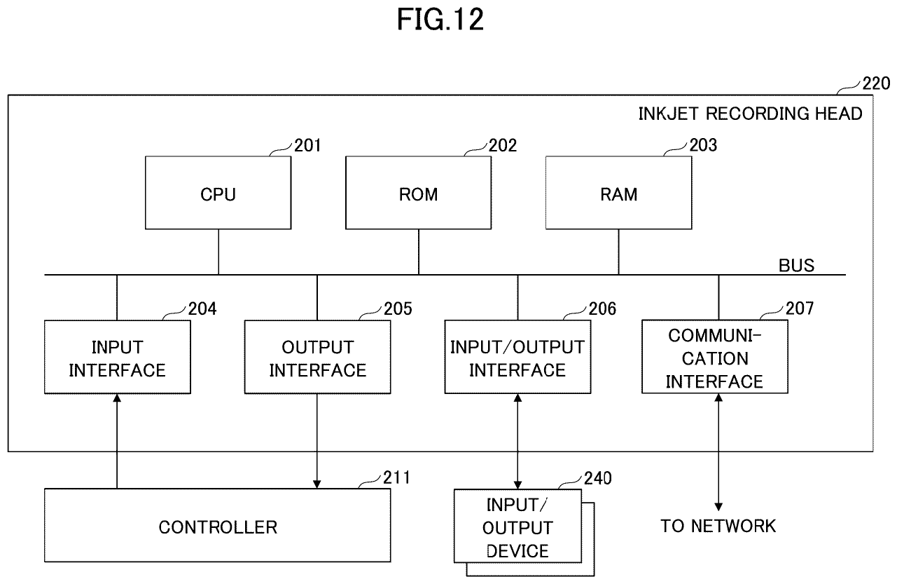

FIG. 12 is a block diagram illustrating an example of the hardware configuration of the inkjet recording head 220 illustrated in FIG. 4. The inkjet recording head 220 has a CPU 201, ROM (Read Only Memory) 202, and RAM (Random Access Memory) 203. The inkjet recording head 220 also has an input interface 204, an output interface 205, an input/output interface 206, and a communication interface 207.

For example, the CPU 201, the ROM 202, the RAM 203, the input interface 204, the output interface 205, the input/output interface 206, and the communication interface 207 are interconnected via a bus.

The CPU 201 executes various programs such as an OS (Operating System) and applications. The ROM 202 stores therein basic programs and various parameters for enabling the CPU 201 to execute various programs. The RAM 203 stores therein various programs executed by the CPU 201, data used in the programs, and the like. For example, the functions of the comparator 50 and the determiner 60 illustrated in FIG. 4 may be implemented by various programs.

The input interface 204 and the output interface 205 are connected to the controller 211. For example, the input/output device 240 such as an HDD (Hard Disk Drive) or a recording medium (not illustrated) is connected to the input/output interface 206. The inkjet recording head 220 need not have the input/output interface 206.

When various programs such as a control program for controlling the operation of the inkjet recording head 220 or an abnormality detection program for detecting a discharge abnormality of a nozzle based on a residual vibration waveform are stored in the recording medium, the programs are transferred from the recording medium to the RAM 203 or the like via the input/output interface 206. The communication interface 207 can connect the inkjet recording head 220 to a network or the like, and in this case, the various programs may be downloaded from the network via the communication interface 207.

The embodiments of the present disclosure are, for example, as follows.
<1> A liquid discharge apparatus including:
   a plurality of piezoelectric elements configured to apply pressure to a plurality of dischargers each including a nozzle configured to discharge liquid;
   a plurality of voltage lines, each being connected to a corresponding one of the piezoelectric elements;
   a driver configured to apply a drive voltage to the plurality of piezoelectric elements via the plurality of voltage lines;
   a selector configured to select one or more of the voltage lines after applying the drive voltage to the plurality of piezoelectric elements and to generate residual vibration data based on a sum of residual vibration voltages resulting from residual vibration appearing on the selected voltage lines;
   an abnormality determiner configured to determine whether or not there is an abnormality in the residual vibration data by comparing the residual vibration data generated by the selector with a reference value that is for determining whether or not there is an abnormality in the residual vibration; and
   a controller configured to detect a discharger having a discharge abnormality based on a result of the determination performed by the abnormality determiner,
      wherein the controller performs:
      a first operation that:
         causes the driver to simultaneously apply a drive voltage to a target group that is one of a plurality of groups each including a predetermined number of the piezoelectric elements,
         causes the selector to simultaneously select a plurality of the voltage lines corresponding to the target group, and
         detects, when the abnormality determiner determines that there is an abnormality in the residual vibration data appearing on the selected plurality of voltage lines, that there is a discharge abnormality in at least one of the plurality of dischargers corresponding to the target group, and
      a second operation that, when the discharge abnormality is detected in the first operation,
         causes the driver to sequentially apply a drive voltage to the plurality of the piezoelectric elements in the target group, and
         causes the selector to sequentially select voltage lines to which the drive voltage was applied, and
         detects that there is a discharge abnormality in the discharger corresponding to the piezoelectric element in which an abnormality in the residual vibration data was determined by the abnormality determiner.
<2> The liquid discharge apparatus according to <1>, wherein: before performing the first operation, the controller performs a third operation that:
   causes the driver to simultaneously apply a drive voltage to the piezoelectric elements in the plurality of groups,
   causes the selector to simultaneously select a plurality of the voltage lines corresponding to the plurality of groups, determines whether or not there is an abnormality in the residual vibration data appearing on the selected plurality of voltage lines, and
   sequentially performs the first operation with each of the plurality of groups as target groups, when a determination is made in the third operation that there is an abnormality in the residual vibration data.
<3> The liquid discharge apparatus according to <2>, wherein the controller sets the reference value used by the abnormality determiner differently for each of the first operation, the second operation, and the third operation.
<4> The liquid discharge apparatus according to <3>, further including a data storage,
   wherein each time the abnormality determiner determines that there is an abnormality in the residual vibration data in the first operation, the abnormality determiner stores a result of the determination in the data storage, and
   wherein the controller performs a fourth operation that:
      causes the driver to simultaneously apply a drive voltage to a high-frequency group in which an occurrence frequency of the abnormality in the residual vibration data is higher than a reference frequency, based on the result of the determination stored in the data storage,
      causes the selector to simultaneously select a plurality of voltage lines corresponding to the high-frequency group, and
      causes the abnormality determiner to determine whether the residual vibration data appearing on the selected plurality of voltage lines is abnormal, and when a determination is made in the fourth operation that there is an abnormality, the controller performs the second operation.
<5> The liquid discharge apparatus according to <4>, wherein a determination is made that there is no abnormality in the residual vibration data in the fourth operation, the controller performs the third operation.
<6> The liquid discharge apparatus according to any one of <1> to <5>, further including a plurality of first switches each configured to connect the driver to one of the plurality of voltage lines,
   wherein the controller is configured to switch off one or more of the switches connected to respective voltage lines selected by the selector.
<7> The liquid discharge apparatus according to any one of <1> to <6>, further including at least one of:
   a first acquirer that is configured to acquire smoothed data obtained by smoothing a waveform of the residual vibration data,
   a second acquirer that is configured to acquire peak values of the waveform of the residual vibration data, or
   a third acquirer that is configured to acquire a phase or a period in which the peak values of the waveform of the residual vibration data appear, wherein
   the controller activates one acquirer among the first acquirer, the second acquirer, and the third acquirer, and causes the abnormality determiner to determine whether or not there is an abnormality, based on a reference value corresponding to the activated acquirer
<8> A control method for a liquid discharge apparatus including a plurality of piezoelectric elements configured to apply pressure to a plurality of dischargers each including a nozzle configured to discharge liquid, a plurality of voltage lines, each being connected to a corresponding one of the piezoelectric elements a driver configured to apply a drive voltage to the plurality of piezoelectric elements via the plurality of voltage lines, a selector, an abnormality determiner, and a controller, the control method including:
   selecting, by the selector, one or more of the voltage lines after applying the drive voltage to the plurality of piezoelectric elements, and generating, by the selector, residual vibration data based on a sum of residual vibration voltages resulting from residual vibration appearing on the selected voltage lines;
   determining, by the abnormality determiner, whether or not there is an abnormality in the residual vibration data by comparing the residual vibration data generated by the selector with a reference value that is for determining whether or not there is an abnormality in the residual vibration;
   performing a third operation, by the controller, that:
      causes the discharge unit having discharge abnormality based on the determination result by the abnormality determiner;
      causes the driver to simultaneously apply a drive voltage to a target group that is one of a plurality of groups each including a predetermined number of the piezoelectric elements,
      causes the selector to simultaneously select a plurality of the voltage lines corresponding to the target group, and
      detects, when the abnormality determiner determines that there is an abnormality in the residual vibration data appearing on the selected plurality of voltage lines, that there is a discharge abnormality in at least one of the plurality of dischargers corresponding to the target group; and
   performing a second operation that, when the discharge abnormality is detected in the first operation,
      causes the driver to sequentially apply a drive voltage to the plurality of the piezoelectric elements in the target group, and
      causes the selector to sequentially select voltage lines to which the drive voltage was applied, and
      detects that there is a discharge abnormality in the discharger corresponding to the piezoelectric element in which an abnormality in the residual vibration data was determined by the abnormality determiner.

Further, the present disclosure is not limited to these embodiments, but various variations and modifications may be made without departing from the scope of the present invention.

What is claimed is:

1. A liquid discharge apparatus comprising:
a plurality of piezoelectric elements configured to apply pressure to a plurality of dischargers each including a nozzle configured to discharge liquid;
a plurality of voltage lines, each being connected to a corresponding one of the piezoelectric elements;
a driver configured to apply a drive voltage to the plurality of piezoelectric elements via the plurality of voltage lines;
a selector configured to select one or more of the voltage lines after applying the drive voltage to the plurality of piezoelectric elements and to generate residual vibration data based on a sum of residual vibration voltages resulting from residual vibration appearing on the selected voltage lines;
an abnormality determiner configured to determine whether or not there is an abnormality in the residual vibration data by comparing the residual vibration data generated by the selector with a reference value that is for determining whether or not there is an abnormality in the residual vibration; and
a controller configured to detect a discharger having a discharge abnormality based on a result of the determination performed by the abnormality determiner,
wherein the controller performs:
a first operation that:
causes the driver to simultaneously apply a drive voltage to a target group that is one of a plurality of groups each including a predetermined number of the piezoelectric elements,
causes the selector to simultaneously select a plurality of the voltage lines corresponding to the target group, and
detects, when the abnormality determiner determines that there is an abnormality in the residual vibration data appearing on the selected plurality of voltage lines, that there is a discharge abnormality in at least one of the plurality of dischargers corresponding to the target group, and
a second operation that, when the discharge abnormality is detected in the first operation,
causes the driver to sequentially apply a drive voltage to the plurality of the piezoelectric elements in the target group, and
causes the selector to sequentially select voltage lines to which the drive voltage was applied, and
detects that there is a discharge abnormality in the discharger corresponding to the piezoelectric element in which an abnormality in the residual vibration data was determined by the abnormality determiner.

2. The liquid discharge apparatus according to claim 1, wherein, before performing the first operation, the controller performs a third operation that:
causes the driver to simultaneously apply a drive voltage to the piezoelectric elements in the plurality of groups,
causes the selector to simultaneously select a plurality of the voltage lines corresponding to the plurality of groups, determines whether or not there is an abnormality in the residual vibration data appearing on the selected plurality of voltage lines, and
sequentially performs the first operation with each of the plurality of groups as target groups, when a determination is made in the third operation that there is an abnormality in the residual vibration data.

3. The liquid discharge apparatus according to claim 2, wherein the controller sets the reference value used by the abnormality determiner differently for each of the first operation, the second operation, and the third operation.

4. The liquid discharge apparatus according to claim 3, further comprising a data storage,
wherein each time the abnormality determiner determines that there is an abnormality in the residual vibration data in the first operation, the abnormality determiner stores a result of the determination in the data storage, and
wherein the controller performs a fourth operation that:
causes the driver to simultaneously apply a drive voltage to a high-frequency group in which an occurrence frequency of the abnormality in the residual vibration data is higher than a reference frequency, based on the result of the determination stored in the data storage,
causes the selector to simultaneously select a plurality of voltage lines corresponding to the high-frequency group, and
causes the abnormality determiner to determine whether the residual vibration data appearing on the selected plurality of voltage lines is abnormal, and when a determination is made in the fourth operation that there is an abnormality, the controller performs the second operation.

5. The liquid discharge apparatus according to claim 4, wherein a determination is made that there is no abnormality in the residual vibration data in the fourth operation, the controller performs the third operation.

6. The liquid discharge apparatus according to claim 1, further comprising a plurality of first switches each configured to connect the driver to one of the plurality of voltage lines,
wherein the controller is configured to switch off one or more of the switches connected to respective voltage lines selected by the selector.

7. The liquid discharge apparatus according to claim 1, further comprising at least one of:
a first acquirer that is configured to acquire smoothed data obtained by smoothing a waveform of the residual vibration data,
a second acquirer that is configured to acquire peak values of the waveform of the residual vibration data, or
a third acquirer that is configured to acquire a phase or a period in which the peak values of the waveform of the residual vibration data appear, wherein
the controller activates one acquirer among the first acquirer, the second acquirer, and the third acquirer, and causes the abnormality determiner to determine whether or not there is an abnormality, based on a reference value corresponding to the activated acquirer.

8. A control method for a liquid discharge apparatus including a plurality of piezoelectric elements configured to apply pressure to a plurality of dischargers each including a nozzle configured to discharge liquid, a plurality of voltage lines, each being connected to a corresponding one of the piezoelectric elements a driver configured to apply a drive voltage to the plurality of piezoelectric elements via the plurality of voltage lines, a selector, an abnormality determiner, and a controller, the control method comprising:
selecting, by the selector, one or more of the voltage lines after applying the drive voltage to the plurality of piezoelectric elements, and generating, by the selector, residual vibration data based on a sum of residual vibration voltages resulting from residual vibration appearing on the selected voltage lines;
determining, by the abnormality determiner, whether or not there is an abnormality in the residual vibration data by comparing the residual vibration data generated by the selector with a reference value that is for determining whether or not there is an abnormality in the residual vibration;
performing a third operation, by the controller, that:
causes the discharge unit having discharge abnormality based on the determination result by the abnormality determiner;
causes the driver to simultaneously apply a drive voltage to a target group that is one of a plurality of groups each including a predetermined number of the piezoelectric elements,
causes the selector to simultaneously select a plurality of the voltage lines corresponding to the target group, and
detects, when the abnormality determiner determines that there is an abnormality in the residual vibration data appearing on the selected plurality of voltage lines, that there is a discharge abnormality in at least one of the plurality of dischargers corresponding to the target group; and
performing a second operation that, when the discharge abnormality is detected in the first operation,
causes the driver to sequentially apply a drive voltage to the plurality of the piezoelectric elements in the target group, and
causes the selector to sequentially select voltage lines to which the drive voltage was applied, and
detects that there is a discharge abnormality in the discharger corresponding to the piezoelectric element in which an abnormality in the residual vibration data was determined by the abnormality determiner.
